(19) United States
(12) Patent Application Publication
(10) Pub. No.: US 2025/0266696 A1
(43) Pub. Date: Aug. 21, 2025

(54) ROTARY STRUCTURE CHARGING BOX AND CHARGING CONNECTING DEVICE

(71) Applicant: Guangzhou Honglian Network Technology Co., Ltd., Guangzhou (CN)

(72) Inventor: Shuwei SUN, Guangzhou (CN)

(21) Appl. No.: 18/983,385

(22) Filed: Dec. 17, 2024

(30) Foreign Application Priority Data
Feb. 18, 2024 (CN) 2024101797895
Mar. 4, 2024 (CN) 2024102383897

(51) Int. Cl. H02J 7/00

(52) U.S. Cl. CPC H02J 7/0042

(57) ABSTRACT

The invention relates to a rotary structure charging box and a charging connecting device, in particular to a backpack, a handbag, a trolley case, a luggage box, etc. with charging function, which are used for data and charging interfaces arranged on the box to facilitate data and power connection of electronic devices such as mobile phones, earphones, mobile power supplies, etc. A rotating head charging interface is adopted, a charging interface and a rotating shaft are arranged on the rotating head, the rotating head is usually parallel to a shell, the charging interface is concealed in a panel, and one end of the rotating head is tilted upward during use to expose the charging interface for convenient connection to the charging device; the structural strength is high, the appearance is smooth, and the joint is tight and waterproof.

### TECHNICAL FIELD

The invention relates to a rotary structure charging box and a charging connecting device, in particular to a backpack, a handbag, a trolley case, a luggage box, etc. with charging function, which are used for data and charging interfaces arranged on the box to facilitate data and power connection of electronic devices such as mobile phones, earphones, mobile power supplies, etc.

### BACKGROUND ART

At present, the charging interface on the box is necessary equipment. The existing charging connecting devices are exposed, slide or lifting type. In the prior arts, there are widespread defects such as low structural strength or complex operation. To solve the above defects, it is necessary to use a new connecting device and connection mode, so that the structural strength is high, the operation is simple and convenient.

### SUMMARY OF THE INVENTION

To solve the above defects, the invention aims to provide a user-friendly charging box with high structural strength and a charging connecting device, a rotating head charging interface is adopted, a rotating head is usually parallel to a shell, and the charging interface is concealed in the top cover, so that the appearance is smooth, and the joint is tight and waterproof, one end of the rotating head is tilted upward during use to expose the charging interface for convenient connection to the charging device; to achieve the effect, the invention adopts the following technical proposal.

A rotary structure charging box comprises a box body and a charging connecting device, wherein the charging connecting device comprises a base, a top cover, a rotating head and an angle limit device, the base is arranged inside the box, part of the top cover is arranged outside the box, the base and the top cover are connected and fixed on the box body through clips or screws, the rotating head is installed on the top cover and is provided with a charging interface and a rotating shaft, and the angle limit device comprises a limit pin or a limit bulge, as well as a limit slot, or a limit hole or a limit notch.

A charging connecting device comprises a base, a top cover, a rotating head and an angle limit device, wherein the base and the top cover are connected and fixed through clips or screws, the rotating head is installed on the top cover and is provided with the charging interface and the rotating shaft, the angle limit device comprises the limit pin or the limit bulge, as well as the limit slot, or the limit hole or the limit notch.

The limit pin is arranged on the base or the top cover or the rotating head.

The limit notch is arranged on the top cover or the rotating head.

The limit bulge is arranged on the rotating head or the top cover.

The limit slot or the limit hole is arranged on the rotating head or the rotating shaft or the top cover, and adopts a plurality of ring arrays.

The invention adopts the following technical proposal: a rotating head charging interface is adopted, a charging interface and a rotating shaft are arranged on the rotating head, the rotating head is usually parallel to a shell, the charging interface is concealed in a panel, and one end of the rotating head is tilted upward during use to expose the charging interface for convenient connection to the charging device.

The invention has the following beneficial effects: due to the use of rotating head charging interface, one end of the rotating head is tilted upward to expose only the rest of built-in charging interface, the structural strength is high, and the rotating head is usually parallel to the shell, and the charging interface is concealed in the panel, so that the appearance is smooth, and the joint is tight and waterproof.

### BRIEF DESCRIPTION OF THE DRAWINGS

The invention is further described in combination with the drawings and examples below.

FIG. 1 is the side view thumbnail for the combination of the charging box and the charging connecting device.

FIG. 2 is the stereogram for the charging connecting device with one end of the rotating head tilted.

FIG. 3 is the stereogram of the parallel state between the rotating head and the top cover of the charging connecting device.

FIG. 4 is the stereogram for the charging connecting device with the other end of the rotating head tilted.

FIG. 5 is the side view of the charging connecting device.

FIG. 6 is the side view profile 1 of the charging connecting device in the proposal I.

FIG. 7 is the side view profile 2 of the charging connecting device in the proposal I.

FIG. 8 is the side view profile 3 of the charging connecting device in the proposal I.

FIG. 9 is the side view of the rotating head and the top cover in the proposal I.

FIG. 10 is the side view of the rotating head in the proposal I.

FIG. 11 is the upward view profile of the rotating head and the top cover in the proposal II.

FIG. 12 is the side view of the rotating head and the top cover in the proposal II.

FIG. 13 is the side view of the rotating head in the proposal II.

FIG. 14 is the side view of the top cover in the proposal III.

FIG. 15 is the side view of the rotating head in the proposal III.

FIG. 16 is the side view of the rotating head and the top cover in the proposal III.

Reference signs: 1: Base; 2: Top cover; 3: (USB) charging interface; 4: Rotating head; 5: (type-c) charging interface; 6: Charging cable; 7: Limit pin; 8: Limit slot or limit hole; 9: Rotating shaft; 10: Limit bulge; 11: Limit notch; 12: Box body; 13: Elastic piece; 14: Reverse buckle.

### DETAILED DESCRIPTION OF THE INVENTION

The exemplary embodiments of the invention are described in detail with reference to the drawings. These exemplary embodiments are provided for ensuring that the invention can be clearly understood by ordinary technicians in the field and can be implemented according to the description herein. The drawings and embodiments are not intended to limit the invention, and the scope of the invention is limited by the claims.

As shown in FIG. 1, a rotating structure charging box is composed of a box body (12) and a charging connecting device, wherein the charging connecting device comprises a base (1), a top cover (2), a rotating head (4) and an angle limit device, the base is arranged inside the box, part of the top cover is arranged outside the box, the base and the top cover are connected and fixed on the box body through clips or screws, the rotating head is installed on the top cover (2) and is provided with charging interfaces (3, 5) and a rotating shaft (9), and the angle limit device comprises a limit pin (7) or a limit bulge (10), as well as a limit slot or limit hole (8) or a limit notch (11); Installation method: Punch a suitable hole on the box body, insert the top cover (2) through a hole on the box, clip the rotating head into the top cover, and connect and fix the base and the top cover onto the box body through clips or screws.

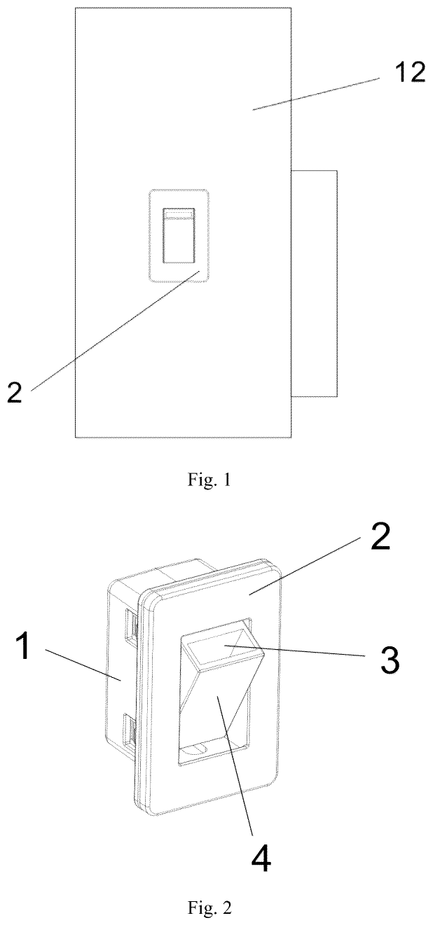

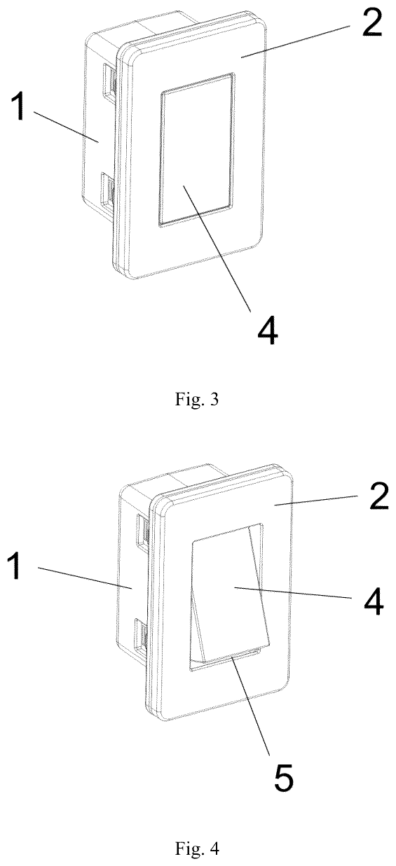

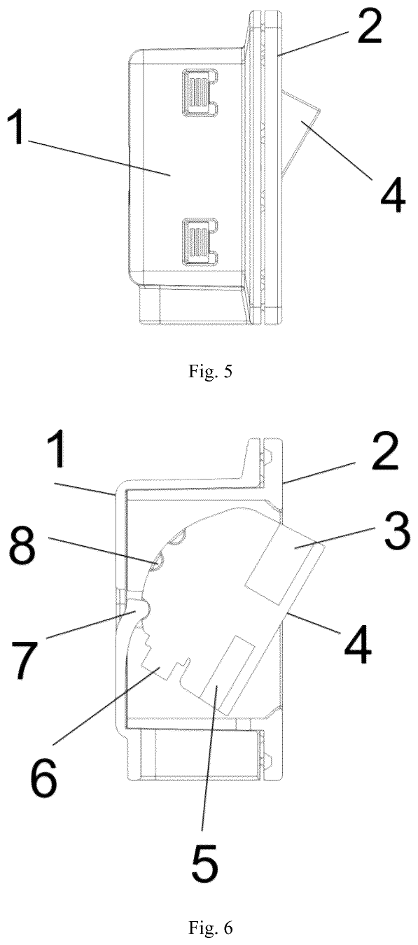

As shown in FIG. 2 to FIG. 6, a charging connecting device comprises a base (1), a top cover (2), a rotating head (4) and an angle limit device, the base and the top cover are connected and fixed on the box body through clips or screws, the rotating head is installed on the top cover (2) and is provided with charging interfaces (3, 5) and a rotating shaft (9), and the angle limit device comprises a limit pin (7) or a limit bulge (10), as well as a limit slot or limit hole (8) or a limit notch (11); the charging connecting device can be installed on a backpack, a computer bag, a trolley box and other products in the same method.

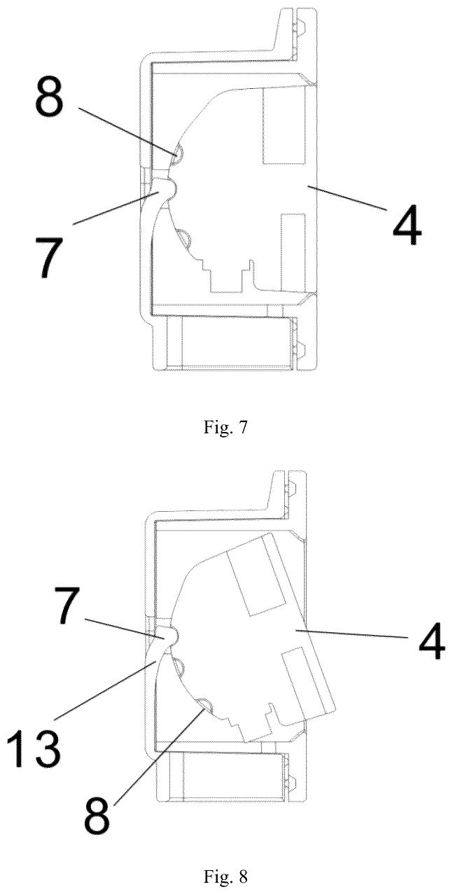

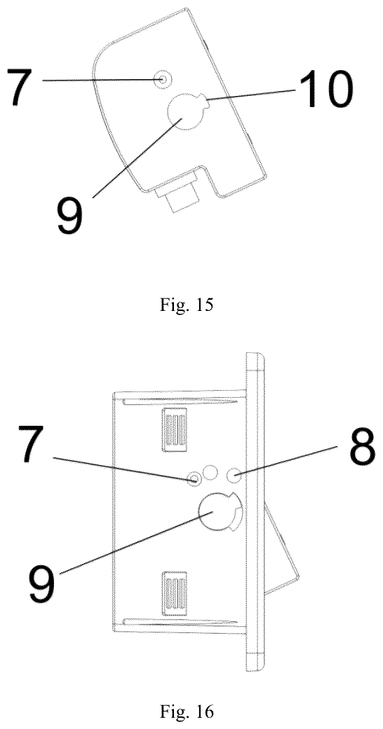

As shown in FIG. 6, FIG. 7, FIG. 8, FIG. 12 and FIG. 15, the limit pin (7) is arranged on the base (1) or the top cover (2) or the rotating head (4), and is matched with the limit slot or limit hole (8) to limit the rotation angle of the rotating head, so that the charging interface (3/5) is just exposed or the rotating head is kept parallel to the top cover; the front end of the limit pin (7) can be arranged as an elastic piece (13) to provide pre-tightening force, or can be directly arranged on the rotating head (4); as shown in FIG. 14, the limit slot or limit hole (8) is arranged on the top cover (2), so that the self-elasticity of the side wall of the top cover (2) can be used to provide pre-tightening force.

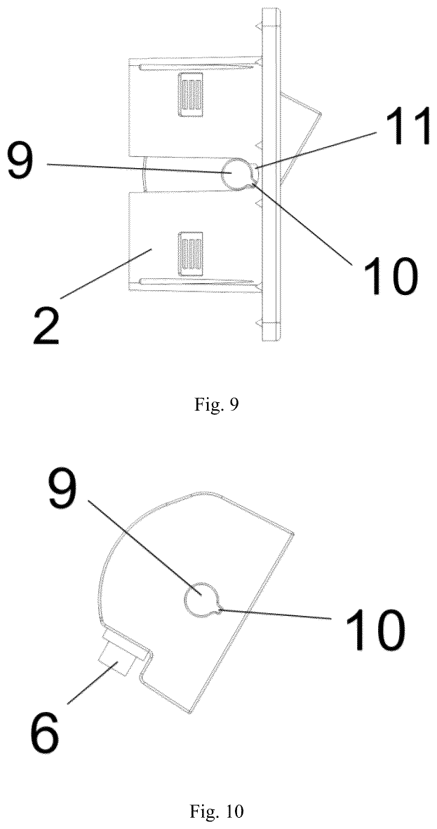

As shown in FIG. 9 and FIG. 12, the limit notch (11) is arranged on the top cover (2) or the rotating head (4) to limit the maximum rotation angle of the rotating head and prevent too large rotation angle.

As shown in FIG. 9, FIG. 10 and FIG. 12, the limit bulge (10) is arranged on the rotating head (4) or the top cover (2), and is matched with an angle limit notch (11) to limit the maximum rotation angle of the rotating head and prevent too large rotation angle

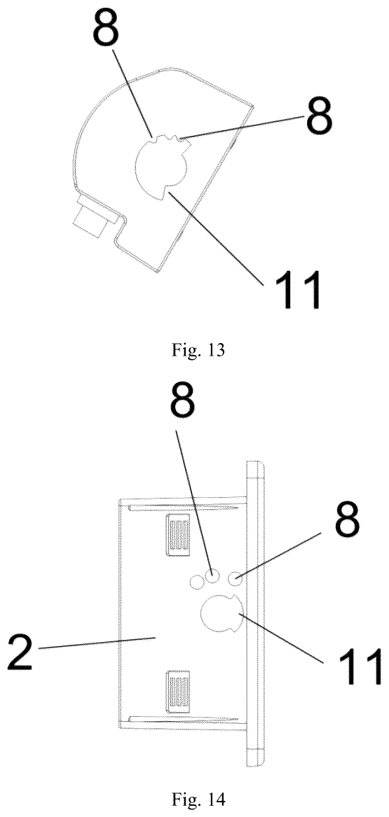

As shown in FIG. 6, FIG. 7, FIG. 8 and FIG. 13, the limit slot or limit hole (8) is arranged on the rotating head (4) or the rotating shaft (9) or the top cover (2), adopts a plurality of ring arrays, and can also be arranged into a bulge shape; at this time, the limit slot or the limit hole or the limit notch is arranged on the elastic piece (13), having the same operating principle and use effect.

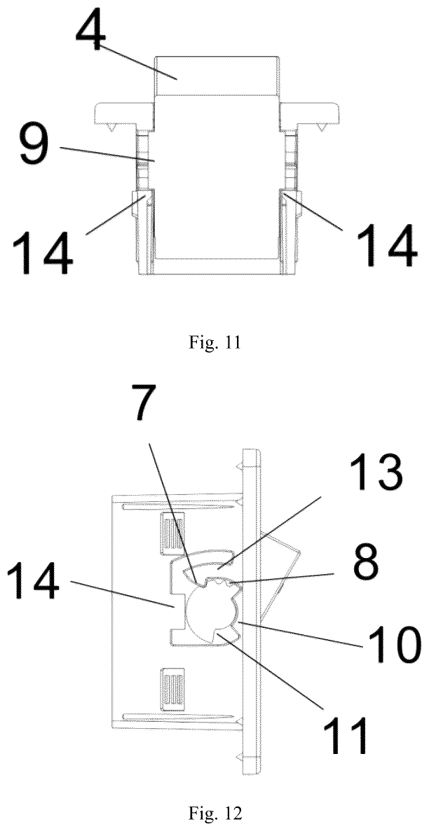

As shown in FIG. 9 or FIG. 11, an opening or a reverse buckle (4) can be arranged on the top cover; when the opening is arranged, the rotating head is compressed by the elastic piece on the base (1); when the reverse buckle is arranged, the rotating head is locked by the reverse buckle.

When in use, one end of the rotating head (4) is press so that the other end thereof is tilted to expose the charging interface (3 or 5) to connect the charging device.

The above embodiments are only preferred embodiments of the invention and are not intended to limit the invention. For the technicians in the field, the invention may be subject to various changes and variations. Any modification, equivalent substitution, improvement, etc. made within the spirit and principles of the invention should fall within the scope of protection of the invention.

1. A rotary structure charging box, characterized by comprising a box body and a charging connecting device, wherein the charging connecting device comprises a base, a top cover, a rotating head and an angle limit device, the base is arranged inside the box, part of the top cover is arranged outside the box, the base and the top cover are connected and fixed on the box body through clips or screws, the rotating head is installed on the top cover and is provided with a charging interface and a rotating shaft, and the angle limit device comprises a limit pin or a limit bulge, as well as a limit slot, or a limit hole or a limit notch.

2. The rotary structure charging box according to claim 1, characterized in that the limit pin is arranged on the base or the top cover or the rotating head.

3. The rotary structure charging box according to claim 1, characterized in that the limit notch is arranged on the top cover or the rotating head.

4. The rotary structure charging box according to claim 1, characterized in that the limit bulge is arranged on the rotating head or the top cover.

5. The rotary structure charging box according to claim 1, characterized in that the limit slot or the limit hole is arranged on the rotating head or the rotating shaft or the top cover, and adopts a plurality of ring arrays.

6. A charging connecting device, characterized by comprising the base, the top cover, the rotating head and the angle limit device, the base and the top cover are connected and fixed through clips or screws, the rotating head is installed on the top cover and is provided with a charging interface and a rotating shaft, and the angle limit device comprises a limit pin or a limit bulge, as well as a limit slot, or a limit hole or a limit notch.

7. The charging connecting device according to claim 6, characterized in that the limit pin is arranged on the base or the top cover or the rotating head.

8. The charging connecting device according to claim 6, characterized in that the limit notch is arranged on the top cover or the rotating head.

9. The charging connecting device according to claim 6, characterized in that the limit bulge is arranged on the rotating head or the top cover.

10. The charging connecting device according to claim 6, characterized in that the limit slot or the limit hole is arranged on the rotating head or the rotating shaft or the top cover, and adopts a plurality of ring arrays.
